(19) United States
(12) Patent Application Publication
(10) Pub. No.: US 2014/0368986 A1
(43) Pub. Date: Dec. 18, 2014

(54) ELECTRONIC DEVICE WITH DISPLAY

(71) Applicant: HON HAI PRECISION INDUSTRY CO., LTD., New Taipei (TW)

(72) Inventor: KUAN-YU LIN, New Taipei (TW)

(73) Assignee: HON HAI PRECISION INDUSTRY CO., LTD., New Taipei (TW)

(21) Appl. No.: 14/192,870

(22) Filed: Feb. 28, 2014

(30) Foreign Application Priority Data
Jun. 14, 2013 (TW) 102121255

(51) Int. Cl. G06F 1/16; F16C 11/10; F16C 11/04

(52) U.S. Cl. CPC G06F 1/1681; F16C 11/04; F16C 11/10
USPC 361/679.27

(57) ABSTRACT

An electronic device includes a base, a display, and a connecting assembly. The connecting assembly includes a pivoting member and a sliding member. The sliding member includes an installation plate and a sliding portion. A first end of the pivoting member is secured to the display. A second end of the pivoting member is pivotably mounted to the installation plate. The base defines an opening slot. The sliding portion is slideably received in the opening slot. The sliding member is slideable relative to the base to slide the display relative to the base via the pivoting member when the sliding portion is slid in the slot.

### FIELD

Embodiments of the present disclosure relate to electronic devices, and particularly to an electronic device with a display.

### BACKGROUND

In many electronic devices, such as notebooks, a display is only rotatable relative to a supporting base. When a horizontal distance between the display and a user needs to be adjusted, the whole notebook must be moved horizontally. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an electronic device.

FIG. 2 is an isometric view of a part of a bottom cover of FIG. 1.

FIG. 3 is an exploded, isometric view of a connecting assembly of the electronic device of FIG. 1.

FIG. 4 is similar to FIG. 3, but viewed from a different aspect.

FIG. 5 is an assembled, isometric view of the electronic device of FIG. 1.

FIG. 6 is an assembled, isometric view of the connecting assembly of FIG. 4.

FIG. 7 is another assembled, isometric view of the electronic device of FIG. 1, showing a sliding member in a first position.

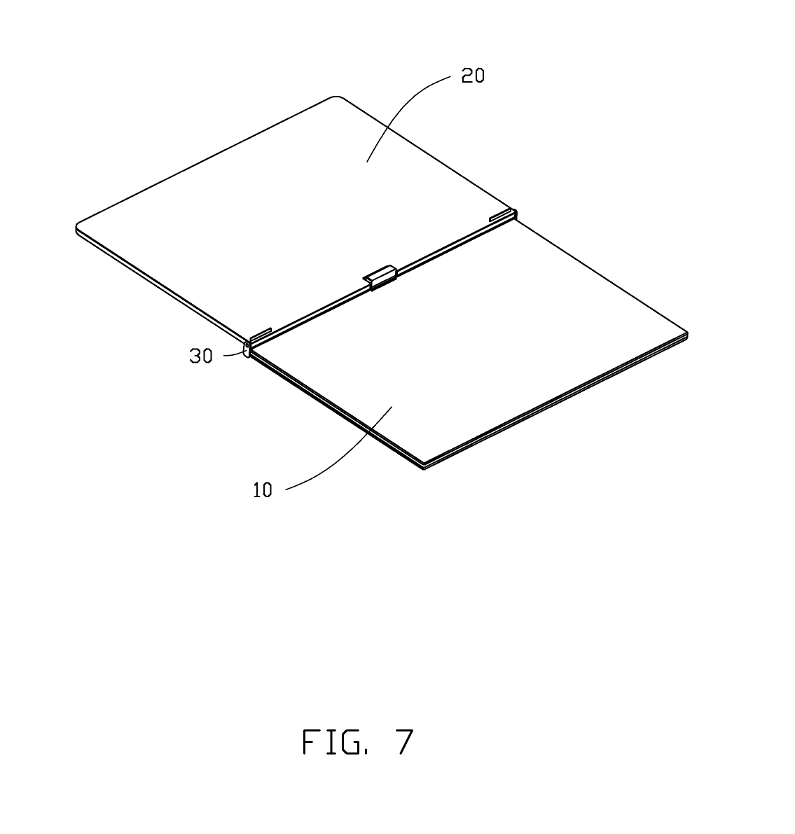

FIG. 8 is similar to FIG. 7, but showing the sliding member in a second position.

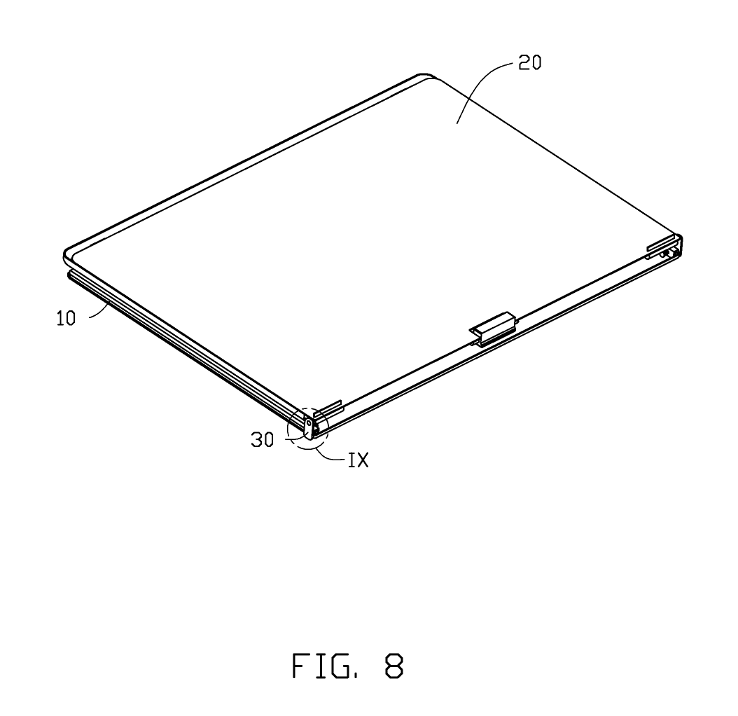

FIG. 9 is an enlarged view of a circled portion IX of FIG. 8.

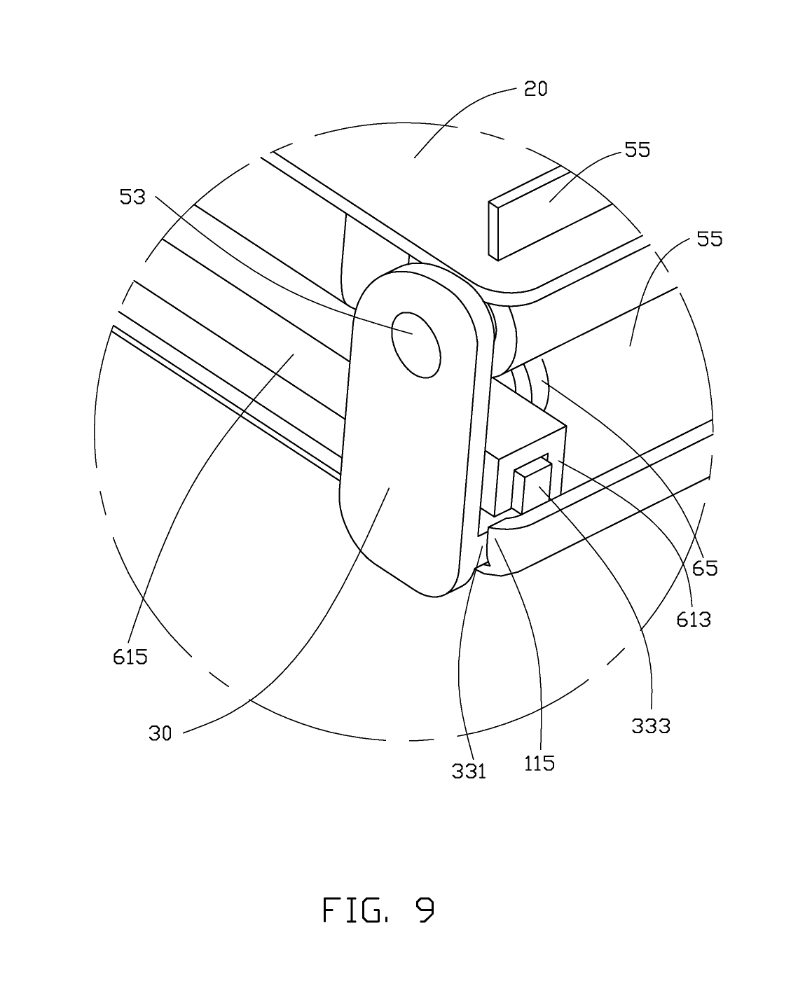

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

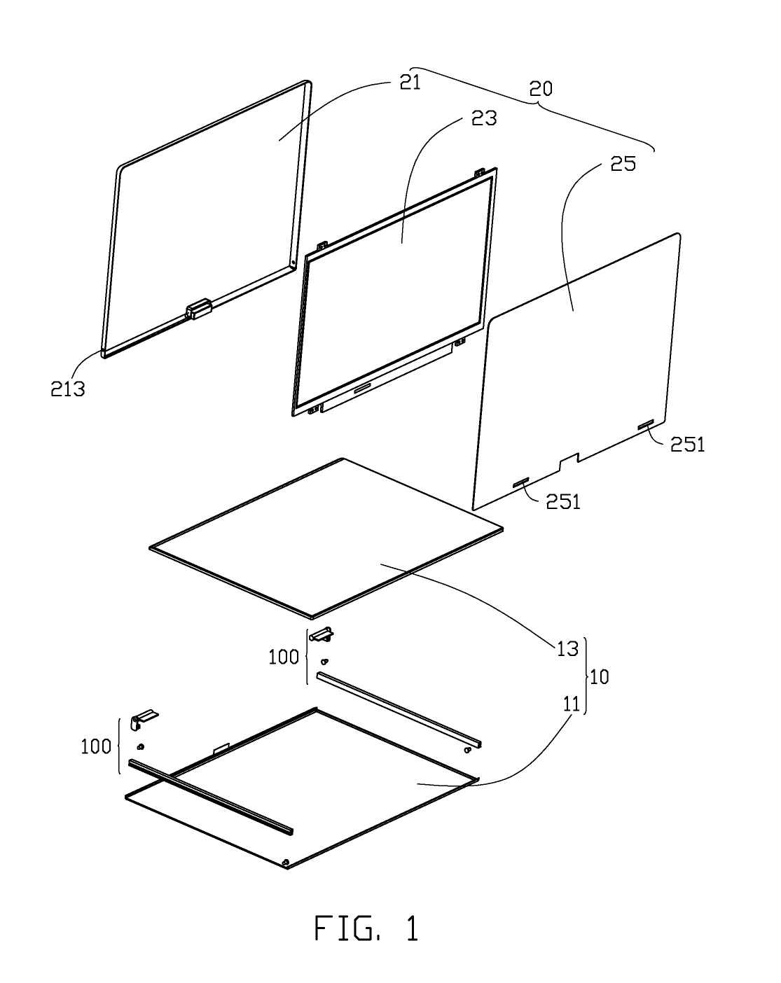

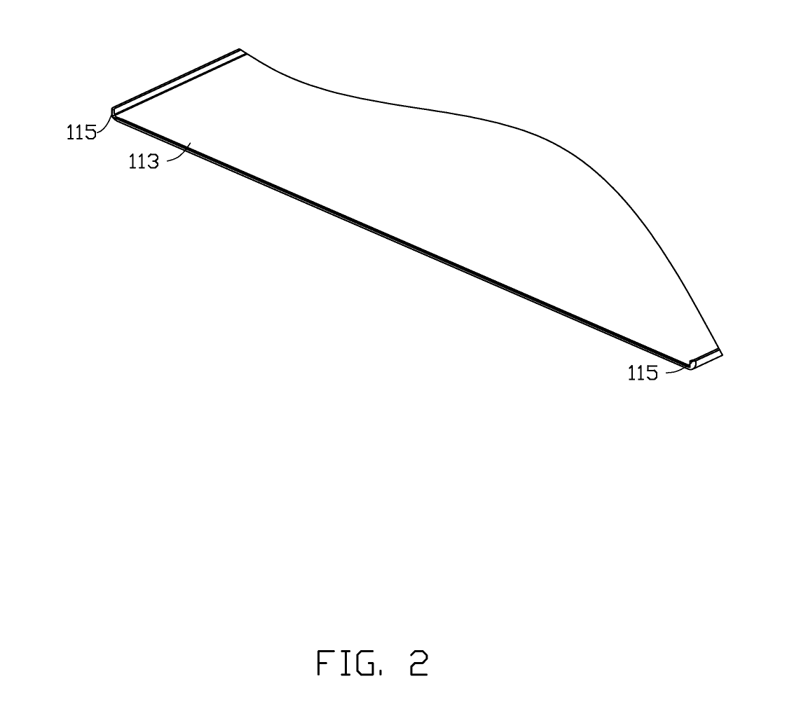

FIGS. 1 and 2 show one embodiment of an electronic device. The electronic device includes a base 10, a display 20, and two connecting assemblies 100.

The base 10 includes a bottom cover 11 and a top cover 13. Each opposite side of the bottom cover 11 defines an opening slot 113. The bottom cover 11 includes a corner 115 at each opposite end of the opening slot 113.

The display 20 includes a covering plate 21, a screen module 23, and a mounting frame 25. The screen module 23 is secured between the covering plate 21 and the mounting frame 25. Each side surface of the covering plate 21 defines a through hole 213. A bottom end of the mounting frame 25 defines two receiving slots 251.

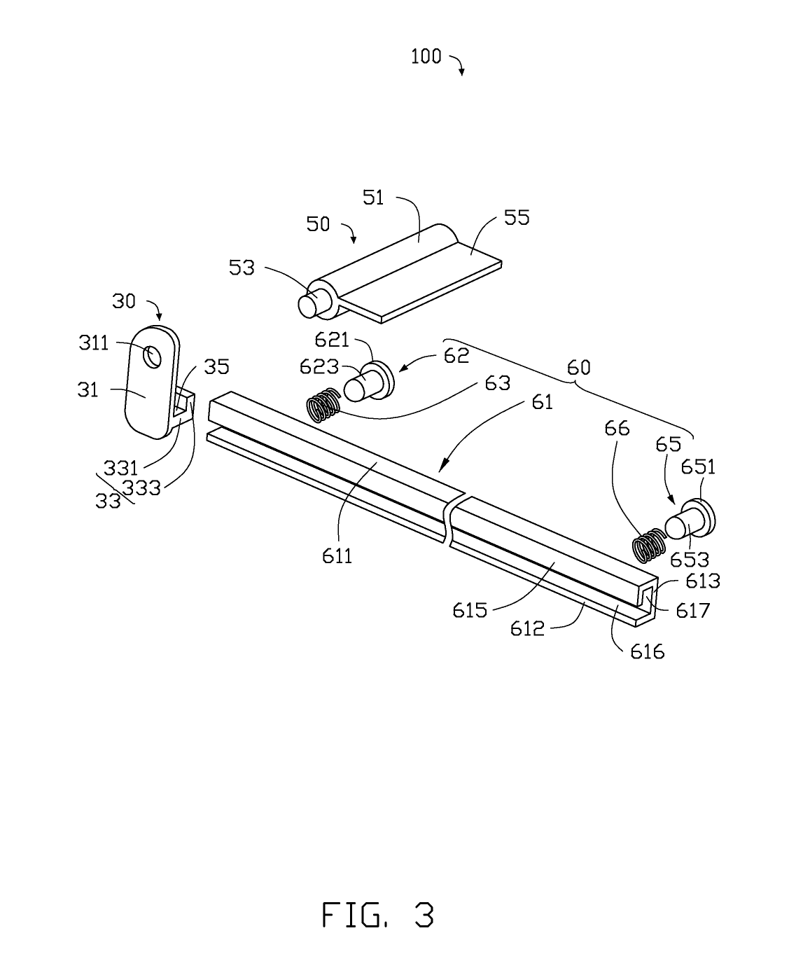

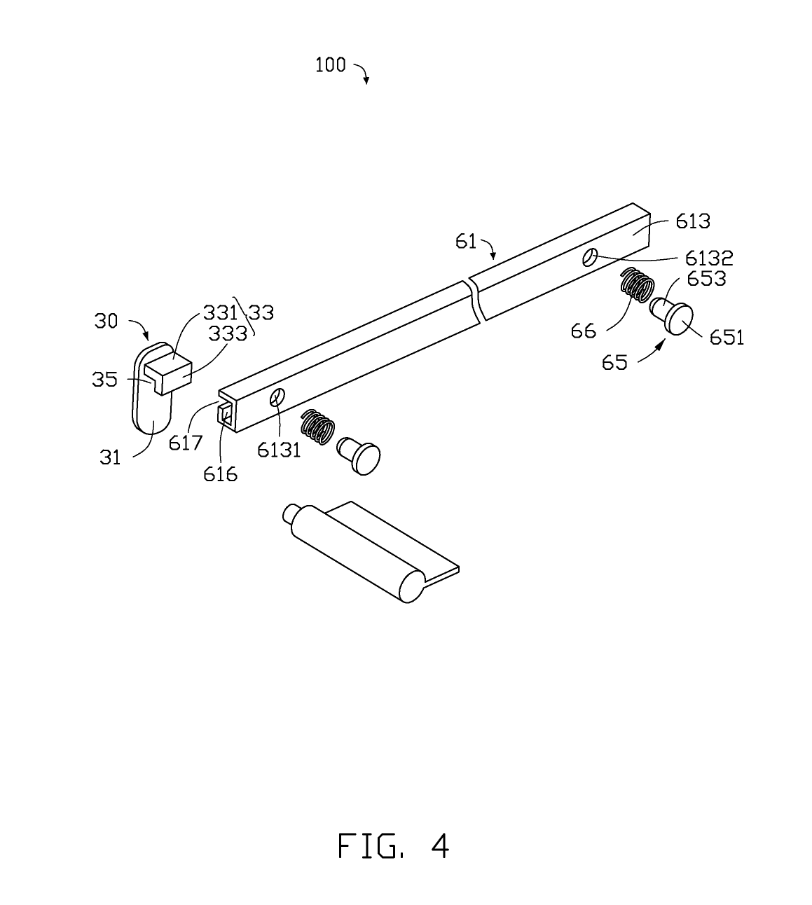

FIGS. 3 and 4 show that the connecting assembly 100 includes a sliding member 30, a pivoting member 50, and a rail module 60.

The sliding member 30 includes an installation plate 31 and a sliding portion 33 located in a side of the installation plate 31. The installation plate 31 defines a pivoting hole 311. The sliding portion 33 includes a sliding block 331 and a limiting block 333 extending from the sliding block 331. In one embodiment, the sliding block 331 is substantially perpendicular to the installation plate 31, the limiting block 333 is substantially perpendicular to the sliding block 331, and the limiting block 333 is substantially parallel to the installation plate 31. An installation slot 35 is defined between the limiting block 333 and the installation plate 31.

The pivoting member 50 includes a pivoting portion 51, a pivoting shaft 53, and a positioning piece 55. The pivoting shaft 53 extends from an outer surface of the pivoting portion 51, and the positioning piece 55 extends from a side surface of the pivoting portion 51. In one embodiment, the pivoting shaft 51 is columniform. In one embodiment, an extending direction of the pivoting shaft 53 is substantially perpendicular to an extending direction of the positioning piece 55. The pivoting shaft 53 can be pivotably received in the pivoting hole 311. The positioning piece 55 can be received in the receiving slot 251.

The rail module 60 includes a sliding rail 61, a first positioning member 62, a first resilient member 63, a second positioning member 65, and a second resilient member 66.

The sliding rail 61 includes a bottom wall 611, a top wall 612, a rear wall 613, and a limiting wall 615. The rear wall 613 extends from an edge of the bottom wall 611. The top wall 612 extends from a top edge of the rear wall 613. The limiting wall 615 extends from an edge of the top wall 612. In embodiment, the top wall is substantially parallel to the bottom wall 611, the rear wall 613 is connected substantially perpendicularly to the top wall 612 and the bottom wall 611, and the limiting wall 615 is substantially parallel to the rear wall 613. The rear wall 613 defines a first positioning hole 6131 and a second positioning hole 6132. The sliding rail 61 defines a sliding slot 616 and a limiting slot 617. The sliding slot 616 is defined in the limiting wall 615. The limiting slot 617 is defined between the top wall 612 and the bottom wall 611 and communicates with the sliding slot 616. In one embodiment, an extending direction of the sliding slot 616 is substantially perpendicular to an extending direction of the limiting slot 617. The limiting slot 617 can be used for receiving the sliding block 331. A distance between the limiting wall 615 and the rear wall 613 is substantially equal to a distance between the installation plate 31 and the limiting block 333.

The first positioning member 62 includes a first positioning piece 621 and a first positioning post 623 extending from a side of the first positioning piece 621. In one embodiment, a cross section of the first positioning member 62 is circular. A diameter of the first positioning post 623 is smaller than a diameter of the first positioning piece 621. The first positioning post 623 can be slideably received in the first positioning hole 6131.

The second positioning member 65 includes a second positioning piece 651 and a second positioning post 653 extending from a side of the second positioning piece 651. In one embodiment, a cross section of the second positioning member 65 is circular. A diameter of the second positioning post 653 is smaller than a diameter of the second positioning piece 651. The second positioning post 653 can be slideably received in the second positioning hole 6132.

In one embodiment, each of the first resilient member 63 and the second resilient member 66 is an extension spring.

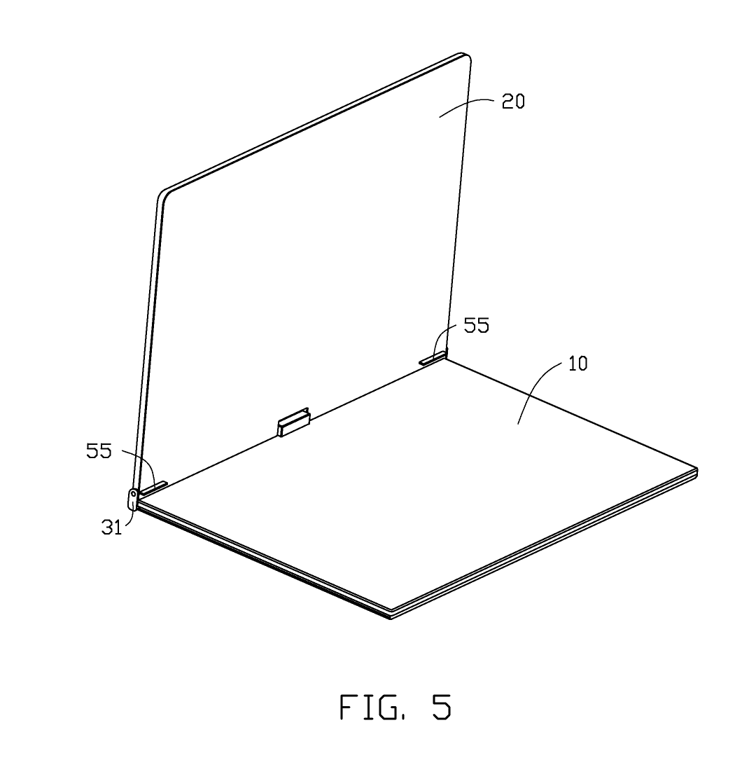

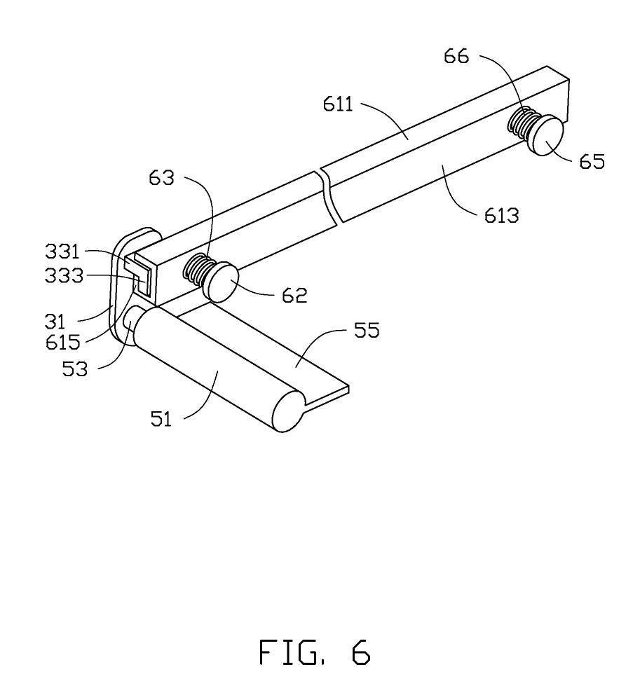

FIG. 5 and FIG. 6 show that in assembly, the sliding member 30 is moved to a side of the sliding rail 61 to align the sliding block 331 to the sliding slot 616, and the limiting block 333 is aligned with the limiting slot 617. The sliding member 30 is further moved until the sliding block 331 is slideably received in the sliding slot 616, and the limiting block 333 is slideably received in the limiting slot 617. A first end of the first resilient member 63 is secured to the first positioning piece 621 with the first positioning post 623 received therein. The first positioning post 623 extends out of the first positioning hole 6131, and a second end of the first resilient member 63 is secured to the rear wall 613. A first end of the second resilient member 66 is secured to the second positioning piece 651 with the second positioning post 653 received therein. The second positioning post 653 extends out of the second positioning hole 6132, and a second end of the second resilient member 66 is secured to the rear wall 613.

The sliding rail 61 is located inside of the base 10 and secured to each side end of the base 10 with the sliding slot 616 aligned with the opening slot 113. The installation plate 31 is located out of the base 10. The pivoting portion 51 is received in the covering plate 21, and the pivoting shaft 53 extends out of the through hole 213. The screen module 23 and the mounting frame 25 are secured to the covering plate 21, and the positioning piece 55 extends out of the receiving slot 251. The pivoting shaft 53 is rotatably received in the pivoting hole 311. In this position, the sliding member 30 is in a first position. The sliding portion 33 is positioned between the first positioning post 623 and one corner 115, and the first positioning post 623 prevents the sliding member 30 from sliding along the sliding slot 616. When the sliding member 30 is in the first position, the display 20 is rotatable relative to the base 10 by the pivoting member 50, and a rotating angle between the display 20 and base 10 is from 0 degree to 180 degrees.

FIG. 5 and FIG. 6 show that the sliding member 30 is slideable relative to the base 10 from the first position to a second position. In sliding the sliding member 30, the sliding member 30 presses the first positioning post 623 to slide the first positioning member 62 away from the rear wall 613 and elastically deforms the first resilient member 63. When the sliding member 30 slides over the first positioning post 623, the first resilient member 63 rebounds to slide the first positioning member 62 towards the rear wall 613 until the first positioning member 62 is located in the initial position. The sliding member 30 is further slid and presses the second positioning post 653 to slide the second positioning member 65 away from the rear wall 613 and elastically deforms the second resilient member 66. When the sliding member 30 slides over the second positioning post 653, the sliding member 30 is blocked by the other corner 65, and the second resilient member 66 rebounds to slide the second positioning member 65 towards the rear wall 613, until the second positioning member 65 is located in the initial position. In this position, the sliding member 30 is located in the second position, the sliding portion 33 is limited between the second positioning post 653 and the other corner 115, and the second positioning member 65 prevents the sliding member 30 from sliding towards the first positioning member 62. When the sliding member 30 is in the second position, the sliding member 30 is operable to slide towards the first positioning member 62 to the first position.

When the sliding member 30 is slid relative to the base 10, the display 20 is slid together with the sliding member 30 through the pivoting member 50. Thus, the display 20 can be horizontally slid relative to the base 10. When the sliding member 30 is in the first position and the display 20 is rotated to have a 180-degree angle relative to the base 10, the sliding member 30 can be slid to the second position so that the electronic device can be used as a tablet computer.

In other embodiments, each of the limiting wall 615 and the rear wall 613 extends from the top cover 13 or the bottom cover 11 directly, and the opening slot 113 is “L” shaped and slideably receives the sliding portion 33.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. An electronic device, comprising:
a base defining an opening slot;
a display; and
a connecting assembly comprising a sliding member and a pivoting member pivotably connecting the display to the base, the sliding member comprising an installation plate and a sliding portion;
wherein a first end of the pivoting member is secured to the display, and a second end of the pivoting member is rotatably mounted to the installation plate; the sliding portion is slideably received in the opening slot; and the sliding member is slideable relative to the base together with the display through the sliding portion.

2. The electronic device of claim 1, wherein the connecting assembly further comprises a rail module secured to the base, the rail module comprises a sliding rail, and the sliding rail defines a sliding slot and a limiting slot; the sliding portion comprises a sliding block and a limiting block, the sliding block is slideably received in the sliding slot, the sliding block is slideably received in the limiting slot, and the limiting block is substantially perpendicular to the sliding block.

3. The electronic device of claim 2, wherein the opening slot is aligned with the sliding slot, and the sliding block is slideably received in the sliding slot through the opening slot.

4. The electronic device of claim 2, wherein the sliding rail comprises a bottom wall, a rear wall, and a limiting wall, and the bottom wall is substantially perpendicular to each of the limiting wall and the rear wall; the bottom wall is secured to the base; the limiting block is located between the rear wall and the limiting wall; the sliding block is located between the limiting wall and the bottom wall, and the limiting wall is located between the limiting block and the installation plate.

5. The electronic device of claim 4, wherein the rail module further comprises a first positioning member configured for preventing the sliding member from sliding, the first positioning member is slideably mounted to the rear wall, and a sliding direction of the first positioning member is substantially perpendicular to a sliding direction of the sliding member.

6. The electronic device of claim 5, wherein the rail module further comprises a first resilient member, a first end of the resilient member is secured to the first positioning member, and a second end of the resilient member is secured to the rear wall.

7. The electronic device of claim 5, wherein the rail module further comprises a second positioning member configured for preventing the sliding member from sliding, the second positioning member is slideably mounted to the rear wall, and a sliding direction of the second positioning member is substantially perpendicular to the sliding direction of the sliding member.

8. The electronic device of claim 7, wherein the sliding member is slideable relative to the base between a first position and a second position; when the sliding member is in the first position, the first positioning member prevents the sliding member from sliding towards the second positioning member, and the display is rotatable relative to the base; and when the sliding member is in the second position, the second positioning member prevents the sliding member from sliding towards the first positioning member, and the display is rotatable relative to the base.

9. The electronic device of claim 8, wherein the base comprises two corners at opposite ends of the opening slot; when the sliding member is in the first position, the sliding portion is blocked between the first positioning member and one of the two corners; and when the sliding member is in the second position, the sliding portion is blocked between the second positioning member and the other corner of the two corners.

10. The electronic device of claim 7, wherein the rail module further comprises a second resilient member; the rear wall defines a positioning hole; the second positioning member comprises a positioning post and a positioning piece; the positioning post is slideably received in the positioning hole; and a first end of the second resilient member is secured to the positioning piece, and a second end of the resilient member is secured to the rear wall.

11. An electronic device, comprising:
a base;
a display; and
a connecting assembly comprising:
a rail module comprising a sliding rail secured to the base, a first positioning member movably mounted to a first end of the sliding rail, and a second positioning member movably mounted to a second end of the sliding rail;
a sliding member comprising an installation plate and a sliding portion; and
a pivoting member pivotably connecting the display to the base;
wherein a first end of the pivoting member is secured to the display, and a second end of the pivoting member is rotatably mounted to the installation plate; the sliding portion is slideably received in the sliding rail; and the sliding member is slideable relative to the base together with the display between a first position and a second position; when the sliding member is in the first position, the sliding portion is blocked by the first positioning member, and the display is rotatable relative to the base; and when the sliding member is in the second position, the sliding portion is blocked by the second positioning member, and the display is rotatable relative to the base.

12. The electronic device of claim 11, wherein the sliding rail defines a sliding slot and a limiting slot; the sliding portion comprises a sliding block and a limiting block, the sliding block is slideably received in the sliding slot, and the sliding block is slideably received in the limiting slot.

13. The electronic device of claim 12, wherein the limiting block is substantially perpendicular to the sliding block.

14. The electronic device of claim 12, wherein the base defines an opening slot aligned with the sliding slot, and the sliding block is slideably received in the sliding slot through the opening slot.

15. The electronic device of claim 12, wherein the sliding rail comprises a bottom wall, a rear wall, and a limiting wall, and the bottom wall is substantially perpendicular to each of the limiting wall and the rear wall; the bottom wall is secured to the base; the limiting block is located between the rear wall and the limiting wall; the sliding block is located between the limiting wall and the bottom wall, and the limiting wall is located between the limiting block and the installation plate.

16. The electronic device of claim 15, wherein the rail module further comprises a second resilient member; the rear wall defines a positioning hole; the second positioning member comprises a positioning post and a positioning piece; the positioning post is slideably received in the positioning hole; and a first end of the second resilient member is secured to the positioning piece, and a second end of the resilient member is secured to the rear wall.

17. The electronic device of claim 11, wherein each of the first positioning member and the second positioning member is slideably mounted to the rear wall, and a sliding direction of each of the first positioning member and the second positioning member is substantially perpendicular to a sliding direction of the sliding member.

18. The electronic device of claim 11, wherein the rail module further comprises a first resilient member, a first end of the resilient member is secured to the first positioning member, and a second end of the resilient member is secured to the rear wall.

19. The electronic device of claim 11, wherein when the sliding member is in the first position, the first positioning member prevents the sliding member from sliding towards the second positioning member; and when the sliding member is in the second position, the second positioning member prevents the sliding member from sliding towards the first positioning member.

20. The electronic device of claim 11, wherein the base comprises two corners at opposite ends of the opening slot; when the sliding member is in the first position, the sliding portion is blocked between the first positioning member and one of the two corners; and when the sliding member is in the second position, the sliding portion is blocked between the second positioning member and the other corner of the two corners.
